(19) United States
(12) Patent Application Publication
(10) Pub. No.: US 2024/0330914 A1
(43) Pub. Date: Oct. 3, 2024

(54) TRUE CASH-DISCOUNTING PAYMENT PROCESSING

(71) Applicant: Denovo Systems, LLC, San Juan, PR (US)

(72) Inventor: Shlomo Zenou, San Juan, PR (US)

(73) Assignee: Denovo Systems, LLC, San Juan, PR (US)

(21) Appl. No.: 18/622,549

(22) Filed: Mar. 29, 2024

Related U.S. Application Data
(60) Provisional application No. 63/462,239, filed on Apr. 26, 2023.
(60) Provisional application No. 63/459,596, filed on Apr. 14, 2023.
(60) Provisional application No. 63/455,538, filed on Mar. 29, 2023.

(51) Int. Cl. G06Q 20/38; G06Q 20/34; G06Q 30/0238; G06Q 30/0283

(52) U.S. Cl. CPC G06Q 20/387; G06Q 20/34; G06Q 30/0238; G06Q 30/0283

(57) ABSTRACT

There is a need for automated payment processing solutions well-suited for reducing the impact of Credit Card Processing Fee (CCPF) on merchants' margins. The present disclosure involves embodiments of the invention that relate to an automated payment processing solution called “Cash Discounting” or the moniker “True Cash Discount™”. The invention allows the merchant to set the base amount and the credit card machine adds a preconfigured CCPF. The machine seamlessly provides the option for the consumer to choose from the Discounted Price for a cash transaction or the credit/debit card transactions. In some embodiments a payment processing technology solution provides for removing the CCPF from the MSRP (Merchant Suggested Retail Price) to arrive at a Discounted Price that is applicable if payment will be made by cash.

### CROSS REFERENCE TO RELATED APPLICATIONS

This application claims the benefit of Provisional U.S. Patent Application No. 63/455,538, filed 29 Mar. 2023 and titled “True Cash-Discounting Payment Processing”; Provisional U.S. Patent Application No. 63/459,596, filed 14 Apr. 2023 and titled “True Cash-Discounting Payment Processing”; and Provisional U.S. Patent Application No. 63/462,239, filed 26 Apr. 2023 and titled “True Cash-Discounting Payment Processing”, all of which are incorporated herein by reference in their entirety.

### BACKGROUND

When a merchant accepts a credit or debit card as a payment option, the merchant must pay a fee to a payment service provider (e.g., an Independent Sales Organization (ISO)). This fee, which may comprise a plurality of components, is referred to in the present disclosure as Credit Card Processing Fee (CCPF). Because CCPFs eat into their margins, merchants would like to pass CCPFs onto the consumers.

In view of merchants' desire to reduce the impact of CCPFs on their margins, ISOs have created an automated payment processing solution called “Cash Discounting.” While there are several variations of Cash Discounting, at a high level, a typical Cash Discounting transaction flow may generally involve the following steps:
Step 1: The merchant enters “cash price” on the credit card machine. Let us call this the base amount.
Step 2: The credit card machine adds a preconfigured CCPF to the base amount to arrive at the “card price.”
Step 3: The credit card machine gives the card price and the cash price as an option for the consumer to choose from.
Step 4: Depending on the option chosen by the consumer, the credit card machine completes the transaction either as a cash transaction or as a credit/debit card transaction.

The following is a more specific illustrative example of the foregoing first three steps:
1. Let us say a sandwich and drink costs $10. The merchant enters $10.00 as the transaction amount.
2. Let us say the CCPF is configured as 4%. The POS machine adds the 4% as 40 cents to the base amount and displays the transaction amount as $10.40.
3. The consumer is given a choice to pay either $10.00 as Cash or $10.40 using credit or debit cards.

Accordingly, by implementing Cash Discounting of the invention, a merchant seamlessly passes on the CCPF to the card holder. As such, merchants' desire to reduce the impact of CCPFs on their margins has been solved by the present invention.

### PRIOR ART

The following further briefly describes some presently-known automated payment processing mechanisms that present customers with different payment amounts when using different payment mechanisms.

### DTI Cash Discount

Debit Technologies, Inc (DTI) developed an automated cash discount mechanism wherein the payment terminal software program is configured such that, as part of the regular standard list product pricing, a small service charge (either a fixed amount or a percentage) is applied to all sales, and a discount is automatically applied when customers pay with cash or a gift card. No discount is given when payment is by a debit card or a credit card. The payment terminal software program automatically determines all discounts and actions based on the payment type.

FIG. 1A depicts a point-of-sale (POS) customer terminal implementing the DTI cash discount mechanism under control of the payment terminal software program, wherein the POS customer terminal user interface displays a product price ($50.00), a service fee ($0.20), and a DTI Cash Discount amount ($0.15).

FIG. 1B depicts an illustrative customer pricing notice that may be used in connection with implementing DTI cash discounting, and which may be posted or displayed, for example, at the POS (e.g., near a POS terminal), as may be recommended and/or required for compliance with credit card association/network agreements and/or certain laws. The customer pricing notice depicted in FIG. 1B lists U.S. Pat. Nos. 8,131,619 B1, 8,478,689 B1, and 8,423,439 B1, each of which is hereby incorporated by reference herein in their entirety.

### Custom Fee

In a so-called Custom Fee payment option, the merchant prices (e.g., store-listed prices) are cash prices (i.e., the already-discounted price for cash payment), and the payment terminal software program is configured such that a Custom Fee (sometimes referred to as “Non-cash adjustment fee”) is added to both credit and debit transactions equally. The Custom Fee may, for example, comprise a percentage of the base price and/or a fixed amount, and may further be tiered.

FIG. 2 depicts an illustrative customer copy receipt generated by a point-of-sale (POS) customer terminal implementing a Custom Fee payment mechanism under control of the payment terminal software program, wherein the depicted receipt reflects the base amount ($56.64) and the Custom Fee ($1.50) presented to the customer during the POS transaction. It may be understood that the depicted receipt reflects the customer having selected the credit card payment option; if the customer had selected the cash payment option, the total amount paid (TOTAL AMT) would instead have been the base amount ($56.64) as the Custom Fee ($1.50) would not have been applied.

### Surcharge Fee—For Credit Only (No Hybrids)

In a so-called Surcharge Fee payment option, a surcharge can only be applied to credit.

The Surcharge is regulated by the card associations/network, and must also comply with state-specific restrictions. The payment terminal software program is configured to comply with such regulations and restriction; for example, appropriate disclaimers may be presented, and if the card presented is a hybrid card (e.g., says “debit” on the card), the surcharge is not allowed and therefore will not be charged, even if the hybrid card is run as credit.

FIG. 3 depicts an illustrative customer copy receipt generated by a point-of-sale (POS) customer terminal implementing a Surcharge Fee payment mechanism under control of the payment terminal software program, wherein the depicted receipt (i) reflects the base amount ($56.64) and the Surcharge presented to the customer during the POS transaction, and (ii) includes a disclaimer (added by the POS terminal) advising as to the surcharge. It may be understood that the depicted receipt reflects the customer having selected the credit card payment option and used a credit card (not a debit or hybrid card).

### Merchant Fee-PIN Debit Only

In a so-called Merchant Fee payment option, a Merchant Fee can only be applied to a PIN (personal identification number) debit transactions. The payment terminal software program is configured such that (i) the Merchant Fee will be automatically applied for such PIN debit transactions, including for hybrid cards run as a PIN debit sale; and (ii) the Merchant Fee will not be applied for credit cards or for hybrid cards run as credit (hybrid cards not run as a PIN debit sale).

FIG. 4 depicts an illustrative customer copy receipt generated by a point-of-sale (POS) customer terminal implementing a Merchant Fee payment mechanism under control of the payment terminal software program, wherein the depicted receipt reflects the base amount ($56.64) and the Merchant Fee ($1.50) presented to the customer during the POS transaction. It may be understood that the depicted receipt reflects the customer having paid by a PIN debit card transaction.

Although the above-summarized automated payment processing mechanisms appear to provide transparent solutions for reducing the impact of CCPFs on merchants' margins, card networks such as Visa, Mastercard, and American Express do not generally approve of such solutions, essentially contending that all traditional cash discounting solutions effectively “Add” a fee to the “Cash Price” to arrive at the “Card Price.”

Accordingly, there remains a need for improvements in automated payment processing technology, including a need for new and alternative automated payment processing solutions well-suited for reducing the impact of CCPFs on merchants' margins, while also being well-suited for acceptance by card associations/networks, as well as compliance with card association/network agreements and any applicable laws. This need extends to new and improved technology for presenting information about payment alternatives, e.g., to make different payment options clear, e.g., to payers, and to make acceptance of payment choices more efficient and less prone to entry mistakes.

### BRIEF SUMMARY OF THE INVENTION

In accordance with some embodiments of the present disclosure, a payment processing technology solution provides for removing the CCPF from the MSRP (Merchant Suggested Retail Price) to arrive at a Discounted Price that is applicable if payment will be made by cash. The present inventors have named this solution “True Cash Discount™” (as well as “Real Cash Discount™”), and, for ease of reference, embodiments thereof may be referred to herein as a “TCD” solution.

In some embodiments of a TCD payment processing technology solution according to the present disclosure, the Discounted Price is also applicable if payment will be a debit payment. In other words, in some embodiments a debit payment may, under certain conditions, be considered a cash payment such that the Discounted Price is applicable to the payment transaction. As further described hereinbelow, such a Debit-Cash-Discount feature may be seamlessly implemented in the payment processing transaction so that the Discounted Price is applied and the payment thereof made following receipt by a payment terminal/device of the debit card information (e.g., without requiring re-entry of card and/or PIN information).

More specifically, in some embodiments, a payment transaction processing system (e.g., a POS payment terminal) comprises at least one processor operable in executing program code stored on at least one computer readable medium to cause the payment transaction processing system to:
(i) store an MSRP amount for a payment transaction to be executed;
(ii) determine (e.g., calculate) a Discounted Price by removing a CCPF from the MSRP (e.g., by deducting a CCPF from the MSRP or otherwise calculating a Discounted Price from the MSRP such that the difference between the MSRP and the Discounted Price is the CCPF);
(iii) receive an input indicative of whether the payment for the transaction will be made by cash or by card;
(iv) execute the transaction according to the Discounted Price in the event that the input indicates that the transaction payment is by cash; and
(v) execute the transaction according to the MSRP in the event that the input indicates that the transaction payment is by card and the card used is a credit card.

In addition, in some embodiments, the program code stored on the at least one computer readable medium will cause the payment transaction processing system to execute the transaction according to the MSRP in the event that the input indicates that the transaction payment is by card and the card used is a debit card. And in some implementations (e.g., which may depend on a configurable setting), a debit card payment transaction will necessarily be according to the MSRP and may not be according to the Discounted Price.

Alternatively, in some embodiments, the program code stored on the at least one computer readable medium may cause the payment transaction processing system to execute the transaction according to the Discounted Price in the event that the input indicates that the transaction payment is by card and the card used is a debit card (e.g., transaction terminal ascertains that the card is a debit card). (For ease of reference, this feature is referred to herein as “Debit-as-Cash”). For example, execution of the transaction according to the Discounted Price may be selectively applied to a debit card transaction, wherein the Discounted Price will be applied only if each of a predetermined set of at least one condition is satisfied, and wherein (in some implementations) the MSRP price will be applied to the debit transaction if at least one of the predetermined set of at least one condition is not satisfied.

By way of example, the predetermined set of at least one condition may comprise, or instead exclusively consist of, the following condition (or a logical equivalent thereof; referred to herein as the “no-dual-price-listing” condition): merchant pricing that may be displayed or otherwise made accessible to consumers/purchasers for the item(s) offered for sale and/or to be purchased (e.g., in-store price display, etc.) may consist of no more than a single price per item. Thus, for example, if separate item prices for cash and card (referred to as “dual-pricing”) were displayed (e.g., for retail store goods; for restaurant menu items, for particular services, etc.) or otherwise made accessible to consumers/purchasers, then the no-dual-price-listing condition would not be satisfied and thus debit card transaction would not be executed at the Discount price and would instead be executed at the MSRP. Whether such a no-dual-price-listing condition is satisfied is generally known by the merchant; so, for example, it may be implemented not as a condition that is expressly checked during execution of each debit transaction, but as a condition that may be confirmed (e.g., by the merchant) as satisfied (or not satisfied) with respect to all prospective debit transactions (e.g., via a configuration setting in a payment terminal management application) so as to enable (or disable) the Debit-as-Cash feature for all such prospective debit transactions without checking the condition during execution of each transaction. In various embodiments, however, the no-dual-pricing-listing and/or one or more other conditions may be checked during execution of individual debit transactions.

In some Debit-as-Cash embodiments (i.e., wherein a debit card transaction may be executed at a Discount price (e.g., like cash)), in response to receiving card information (e.g., via a magnetic-strip reader, a contact chip reader, and/or a contactless (e.g., NFC (near-field-communication)) reader for card chips or other contactless-payment-devices (e.g., mobile phone executing a card payment application, such as Apple Pay, etc.), a payment terminal may automatically calculate the Discount price (e.g., equivalent to cash discount) and automatically apply it to the payment transaction flow to complete the payment transaction at the Discount price without re-entry, wherein-prior to authorization—the payment terminal accesses a BIN file database that at or otherwise locally accessible to the payment terminal and/or at the gateway. Accordingly, for example, the consumer—although paying by card instead of cash-will automatically receive the savings as if paid by cash, and without requiring re-entry of, e.g., card information or other information, such as a PIN.

In some embodiments, to provide for the transaction processing system to receive the input indicative of whether the payment for the transaction will be made by cash (see, e.g., step (iii) above), the transaction processing system may present two options to a consumer for the transaction: (i) pay MSRP if the consumer pays by Card, or (ii) pay Discounted Price if the consumer pays by cash. In some implementations, such option information—which does not distinguish between credit and debit cards—may also be presented to the consumer when the Debit-as-Cash feature is enabled (wherein debit card transactions may in fact be automatically be executed at the Discounted Price). Such option information may be presented to the consumer via a display of a merchant device (e.g., the POS terminal) of the transaction processing system. Alternatively or additionally, such option information may be communicated by the transaction processing system (e.g., by the merchant device) to a consumer device (e.g., a mobile smartphone; e.g., communication via text or NFC) on which the options are displayed.

The payment transaction processing system may be configured so that the consumer directly inputs into the merchant terminal/device the input indicative of whether the transaction will be made by cash. Alternatively or additionally, the payment transaction processing system may be configured so that, in response to a consumer informing (e.g., orally or otherwise) a merchant of the consumer's option selection, the merchant directly inputs the input indicative of whether the transaction will be made by cash.

Alternatively or additionally, the merchant device may be configured for communication with a consumer's mobile device (e.g., mobile smartphone; e.g., communication via text or NFC, etc.) into which the consumer may directly input the input indicative of whether the transaction will be made by cash, and the consumer's mobile device will communicate this information to the merchant device. Alternatively or additionally, the input indicative of whether the transaction will be made by cash may be the input of card information into the merchant terminal/device (e.g., via a card reader, or NFC, etc.).

### BRIEF DESCRIPTION OF THE DRAWINGS

FIG. 1A depicts a point-of-sale (POS) customer terminal implementing the DTI cash discount mechanism under control of the payment terminal software program.

FIG. 1B depicts an illustrative customer pricing notice that may be used in connection with implementing DTI cash discounting.

FIG. 2. depicts an illustrative customer copy receipt generated by a point-of-sale (POS) customer terminal implementing a Custom Fee payment mechanism under control of the payment terminal software program.

FIG. 3 depicts an illustrative customer copy receipt generated by a point-of-sale (POS) customer terminal implementing a Surcharge Fee payment mechanism under control of the payment terminal software program.

FIG. 4 depicts an illustrative customer copy receipt generated by a point-of-sale (POS) customer terminal implementing a Merchant Fee payment mechanism under control of the payment terminal software program.

FIG. 5. depicts an illustrative display/screen on a user interface of a credit card machine (e.g., a POS terminal) executing a POS payment application into which an MSRP of $13.52 has been entered.

FIG. 6. depicts an illustrative display/screen on the user interface of the credit card machine (e.g., a POS terminal) and a POS payment application of FIG. 5, showing a $13.00 Cash Payment option (the Discount Price option) and a $13.52 Card Payment option (the MSRP option), corresponding to $0.52 Cash Discount.

FIG. 7. depicts an illustrative customer copy paper receipt generated for a credit card transaction with respect to the illustrative payment process described with reference to FIG. 5 and FIG. 6, with the receipt being generated by the credit card machine (e.g., the POS terminal) for which the user interface is depicted in FIGS. 5 and 6.

FIG. 8. depicts an illustrative customer copy paper receipt generated for a cash transaction with respect to the illustrative payment process described with reference to FIG. 5 and FIG. 6, with the receipt being generated by the credit card machine (e.g., the POS terminal) for which the user interface is depicted in FIGS. 5 and 6.

FIG. 9 depicts an illustrative display/screen of a Register/Cash Discount Calculator utility on the user interface of the POS payment application and the credit card machine (e.g., a POS terminal) of FIG. 5.

FIG. 10A depicts an illustrative configuration interface screen/display of a Terminal (parameter) management system.

FIG. 10B depicts a magnified portion of the interface screen/display shown in FIG. 10A.

FIG. 11A depicts an illustrative dual-pricing display (e.g., for payment type selection), similar to that of FIG. 6, but including three distinct fields/softkeys respectively indicating that a Cash payment will incur the discounted payment amount (e.g., $1.00 in this example), a Debit payment likewise will incur the discounted payment amount (e.g., $1.00 in this example), and that a Card payment (e.g., credit card) will incur the undiscounted, MSRP/List price (e.g., $1.03 in this example).

FIG. 11B depicts an illustrative implementation of a dual-pricing display (e.g., for payment type selection), similar to that of FIG. 11A, but wherein a debit field/softkey indicates that a PIN-based debit card transaction will incur a Discounted Price (e.g., $10.00 in this example).

FIG. 12 depicts an illustrative customer copy paper receipt generated for a credit card transaction (in the amount of $20.80 in this example), wherein the receipt includes the message “If paid with cash, you could've saved $0.80”.

FIG. 13. depicts the Cash price for four items entered into the Discount Calculator, which determined the respective card prices for each item as well as the Cash Total (shown as $260.00 in this example), the Card Total (shown as $270.40 in this example), and the Discount Amount (shown as $10.40 in this example).

FIG. 14 depicts an active Discount Calculator display of the Cash Register that includes (i) a first field for displaying the value of each cash item as it is typed into the Discount Calculator (e.g., the field comprising $80 in the upper right), and (ii) a second field for displaying the running sum of the entered cash values ($180 in this example, wherein the $180 will become $260 once the user/merchant selects the plus softkey (if another cash value is to be entered) or selects the “Enter” softkey (e.g., if $80 is the last cash value for the last item to be entered for the transaction, which it is in this example).

FIG. 15 depicts an illustrative transaction screen, showing the $270.40 MSRP/List price total for the transaction and upon the user selecting the “OK” softkey, the process will proceed.

FIG. 16 depicts the display of the dual price option so the customer/consumer may be presented with the Cash payment option and the Card payment option and they can select their payment preference of either the “Cash Payment” or “Card Payment” via the softkey.

FIG. 17 depicts an illustrative prompt that may be displayed to the consumer/customer (e.g., via the terminal user interface/display) in the event that the user selected Card Payment and presented a debit card that was automatically processed as a Cash payment.

FIG. 18 depicts an illustrative implementation of a Discount Calculator user interface, in accordance with some embodiments where the successive item MSRPs are entered using the plus (+) sign.

FIG. 19A depicts an illustrative transaction processing screen corresponding to that of FIG. 5, but with an “Enter amount” prompt instead of an “Enter MSRP” prompt.

FIG. 19B depicts an illustrative Cash Register or a Discount Calculator user interface (invoked via the Register icon/softkey on the FIG. 19A user interface display.

FIG. 19C and FIG. 19D, FIG. 19C depicts an illustrative itemized and total dual-price listing (card and cash prices). Upon selection of the “Pay” icon/softkey on the dual-price listing display of FIG. 19C, the transaction process may proceed to cause display of the user interface/display of FIG. 19D from which payment type may be selected.

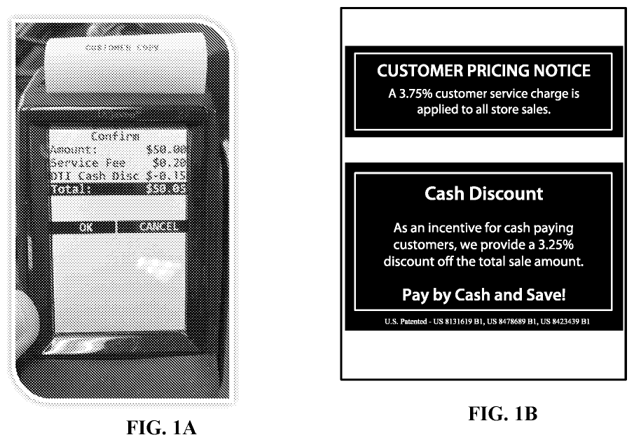

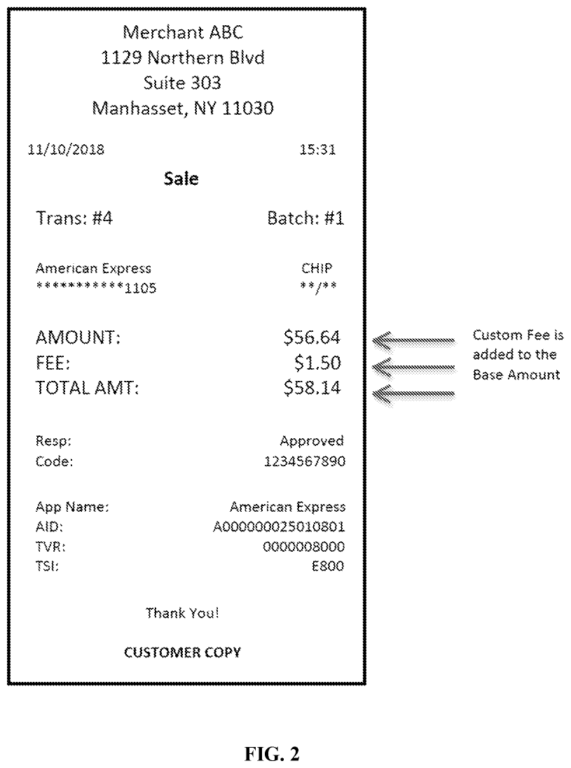

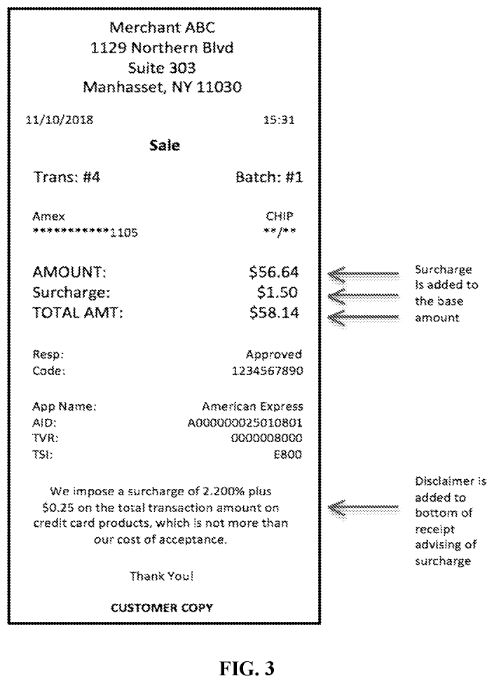

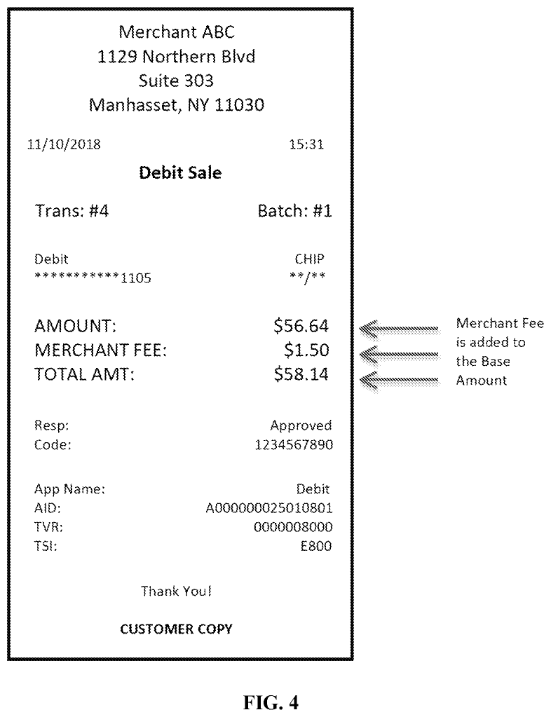

### DETAILED DESCRIPTION OF PROFFERED EMBODIMENTS

### TCD Solution Via Machine

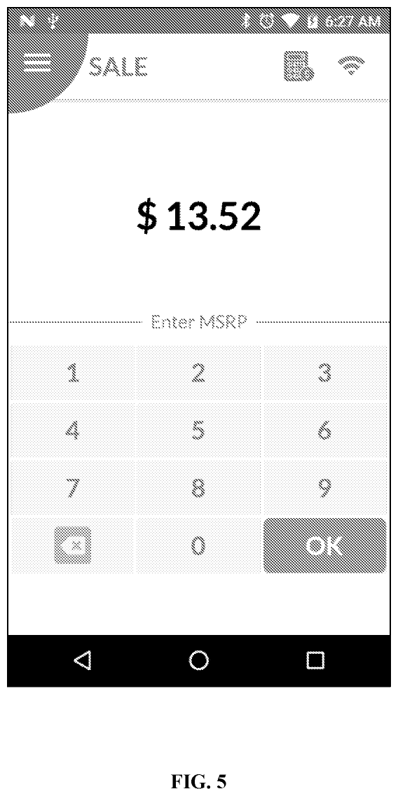

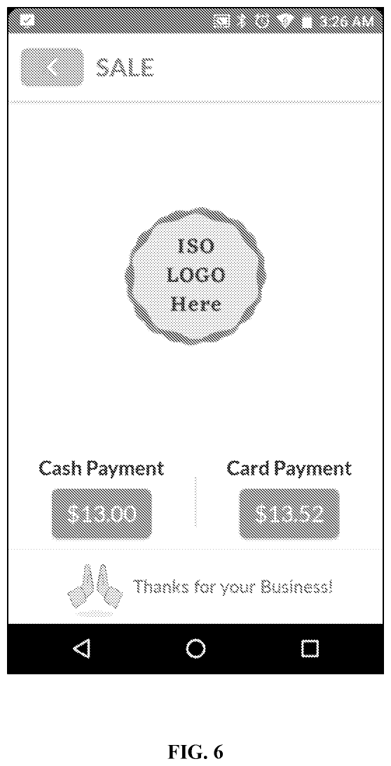

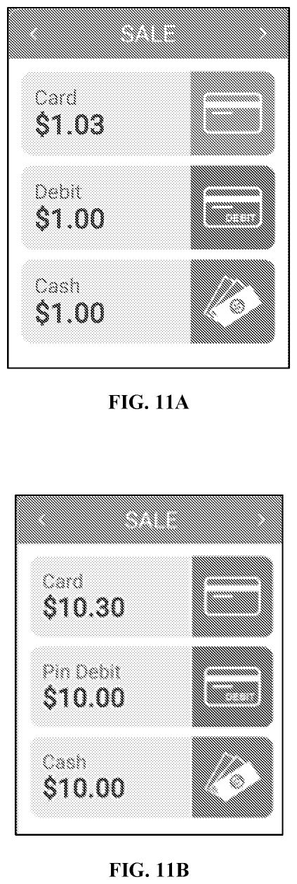

By way of illustrative example, a TCD solution implemented by a processor-implemented payment transaction processing system comprising a credit card machine (e.g., executing TCD application software stored in the credit card machine) according to some embodiments may include the following steps:
Step 1: A merchant enters MSRP (sometimes also referred to as List Price) on a credit card machine.
By way of non-limiting example of this step, FIG. 5 depicts an illustrative display/screen on a user interface of a credit card machine (e.g., a POS terminal) executing a POS payment application into which an MSRP of $13.52 has been entered.
Step 2: Credit card machine removes (e.g., deducts) a preconfigured CCPF from MSRP (e.g., the List Price) to arrive at the Discounted Price applicable for a Cash payment (and also applicable to debit payment if the Debit-as-Cash feature is being implemented and/or enabled subject to satisfaction of the no-dual-pricing-listing condition).
Step 3: Credit card machine displays (i) the MSRP value as the “Card Price” and (ii) the Discounted Price value as the “Cash Price” as options for the consumer to choose from.
By way of non-limiting example of this step, FIG. 6 depicts an illustrative display/screen on the user interface of the credit card machine (e.g., a POS terminal) and a POS payment application of FIG. 5, showing a $13.00 Cash Payment option (the Discount Price option) and a $13.52 Card Payment option (the MSRP option), corresponding to $0.52 Cash Discount. It may be understood that Step 2 and Step 3 may be performed in response to a user selecting “OK” (after entering $13.52) into the interface/display of FIG. 5.
In accordance with some embodiments, the fields containing the Cash Payment amount and the Card Payment amount depicted in FIG. 6 may be respective soft keys for selection of the payment option.
As noted above, in some implementations, such an information display—which does not distinguish between credit and debit cards—may be presented to the consumer even when the Debit-as-Cash feature is enabled (wherein debit card transactions may in fact be automatically be executed at the Discounted Price).
But in various alternative implementations of a TCD payment application according to some embodiments, if the Debit-as-Cash feature is enabled, then a dual pricing display (e.g., which may be used for payment type selection) may identify the Cash discount price as being applicable to Cash as well as Debit card transactions (e.g., PIN debit and/or signature debit). For instance, FIG. 11A depicts an illustrative dual-pricing display (e.g., for payment type selection), similar to that of FIG. 6, but including three distinct fields/softkeys respectively indicating that a Cash payment will incur the discounted payment amount (e.g., $1.00 in this example), a Debit payment likewise will incur the discounted payment amount (e.g., $1.00 in this example), and that a Card payment (e.g., credit card) will incur the undiscounted, MSRP/List price (e.g., $1.03 in this example). In some implementations, such a dual-pricing display may further distinguish between PIN-based debit and signature-based debit, though this may typically be unnecessary in most TCD applications (e.g., because any debit card payment may typically qualify—and be processed—as a cash payment at the Discounted Price; in any case, FIG. 11B depicts an illustrative implementation of a dual-pricing display (e.g., for payment type selection), similar to that of FIG. 11A, but wherein a debit field/softkey indicates that a PIN-based debit card transaction will incur a Discounted Price (e.g., $10.00 in this example).
Step 4: Depending on the option chosen by the consumer, the credit card machine completes the transaction either as a cash transaction (i.e., according to the Cash/Discounted Price) or as a card transaction.
More specifically, the credit card machine completes credit card transactions according to the MSRP Price. If the Debit-As-Cash feature is not implemented and/or not enabled (e.g., not included in the payment application software; or included in the payment application software but not enabled and/or the no-dual-pricing condition is not satisfied, etc.), then all debit card transactions completed by the credit card machine are according to the MSRP.
If, however, the Debit-as-Cash feature is being implemented (e.g., included in the payment application software and enabled subject to satisfaction of the no-dual-price-listing condition), then the credit card machine completes debit card transactions according to the Discount Price. As described above, the credit card machine (e.g., the POS terminal) may automatically apply the Discount Price to the debit card transaction (automatically completing the transaction at the Discount Price), and the savings may be shown to the consumer on the credit card machine display and/or on an electronic or paper receipt.
In some embodiments, prior to the credit card machine automatically applying the Discount Price (and automatically completing the transaction at the Discount Price) for a debit card transaction (and prior to authorization), the credit card machine (e.g., the POS terminal) may access a BIN file database, wherein the BIN file is at or otherwise locally accessible to the payment terminal and/or at the gateway. In some embodiments, automatically applying the Discount price to the debit card transaction (and completing the transaction at the Discount Price) may be conditioned on the credit card machine identifying the card in the BIN file during such access prior to authorization.
Step 5: If paid by Card at the MSRP, the difference between MSRP and Discounted price (corresponding to the CCPF) is captured as an “Unclaimed or Unrealized Discount” and reported (e.g., via one or more communications networks) to at least one of ISO, Merchant, and Consumer/Purchaser (e.g., wherein the reported “Unclaimed or Unrealized Discount” may be used for transaction accounting and/or records purposes).

While the foregoing illustrative example has been described with respect to a credit card machine, those skilled in the art will understand that embodiments according to the present disclosure may be implemented with any terminal or device configured to accept payment from consumers/purchasers, including, for example, a smartphone, Tablet, or PDA (personal digital assistant).

In addition, in connection with various payment terminal and/or system configurations implementing Debit-as-Cash according to some embodiments of the present disclosure, there are various ways that a BIN file may be accessed and a transaction completed (e.g., in relation to Step 4), such as the following examples.
1. In some implementations, the POS device/terminal communicates with a payment processor (e.g., ISO) via a payment Gateway. In some such implementations, the logic of verifying the BIN file and applying a Discounted Price will be done by the Gateway, which will then proceed with causing the debit transaction to be automatically completed at the cash Discount Price before informing the POS device terminal (and hence the Merchant as well as the consumer/purchaser) that the transaction qualified for the Discounted Price. In other words, prior to completion of the payment transaction, the POS/payment device/terminal (and hence the Merchant as well as the consumer/purchaser) will not be informed of the transaction having qualified for the discount price; they will become aware of this information only after the payment transaction has been completed at the Discount Price. In this regard, it will be understood that the transaction information initially communicated to the Gateway by the POS device/terminal will include the MSRP price as well as the Discount Price (or Discount Amount).
2. In some implementations, the POS device/terminal is a standalone device that communicates directly with a payment processor (e.g., ISO). In some such implementations, the POS device/terminal will access BIN File information via an API (application programming interface), and then (subject to verification of the BIN File information) will itself apply the Discount Price (i.e., on the POS device/terminal). Then, prior to proceeding with completion of the payment transaction (e.g., by communicating with the payment processor), the POS/payment device/terminal may inform the Merchant (and the consumer/purchaser) that the transaction qualified for the Discounted Price. As may be appreciated, in such implementations the Discounted Price—but not the MSRP—is communicated by and external to the POS device/terminal.
   Receipts from TCD Transactions

In some embodiments, the TCD transaction processing system may provide a paper and/or electronic receipt (e.g., an email receipt) to the purchaser (e.g., the consumer) for a completed transaction.

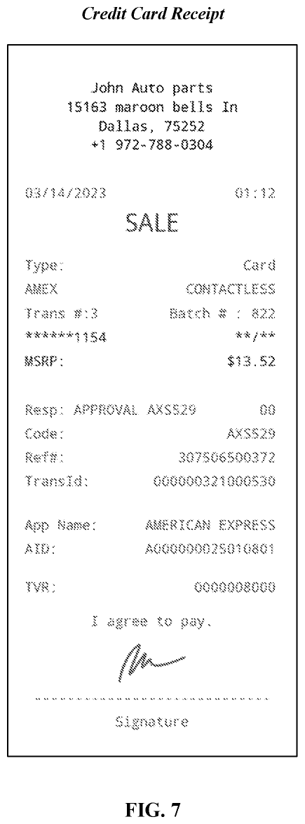

By way of a non-limiting example, FIG. 7 depicts an illustrative customer copy paper receipt generated for a credit card transaction with respect to the illustrative payment process described with reference to FIG. 5 and FIG. 6, with the receipt being generated by the credit card machine (e.g., the POS terminal) for which the user interface is depicted in FIGS. 5 and 6. As shown, the depicted receipt reflects the credit card payment of the MSRP ($13.52).

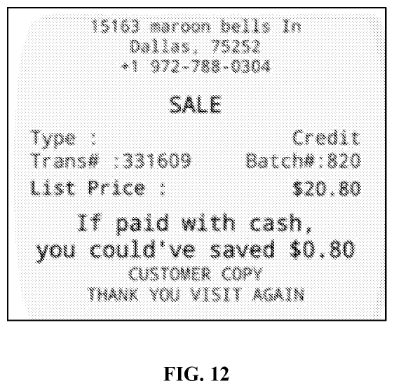

In some implementations, a receipt for a credit card payment may also include a line indicating unrealized savings due to payment by credit card (or, similarly, indicating savings that could have been realized if payment had been made by cash). Such a line indicating unrealized savings may be implemented as a user-selectable configuration option (e.g., selectively enabled, with a user-specified prompt/message), such as via a STEAM or other terminal configuration interface or platform, which are further described herein. By way of a non-limiting example, FIG. 12 depicts an illustrative customer copy paper receipt generated for a credit card transaction (in the amount of $20.80 in this example), wherein the receipt includes the message “If paid with cash, you could've saved $0.80”.

In some embodiments, information shown (displayed) on a receipt for a cash transaction (i.e., a cash receipt) may include the following:
MSRP
Discounted price.
A Savings message, along with the difference between the MSRP and the Discounted Price.

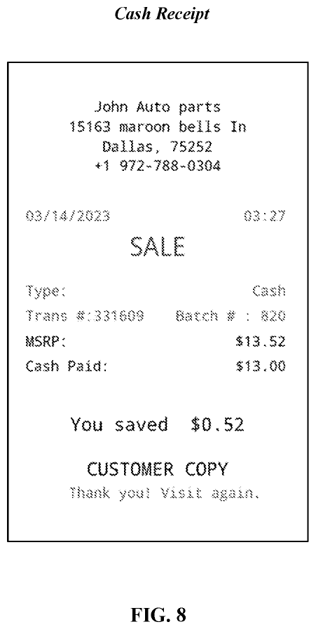

In some implementations, the Savings message comprises a configurable label that can be set by the merchants to their liking. For example, if a merchant were to configure the Savings message label as “You saved” and the difference between the MSRP and the Discounted Price were $0.52, then a line showing “You saved $0.52” would be included in the cash receipt, such as the cash receipt shown in FIG. 8. More specifically, FIG. 8 depicts an illustrative customer copy paper receipt generated for a cash transaction with respect to the illustrative payment process described with reference to FIG. 5 and FIG. 6, with the receipt being generated by the terminal machine (e.g., the POS terminal) for which the user interface is depicted in FIGS. 5 and 6.

Such Savings messages may also be included on the receipt for debit card payment transactions completed at the Discount Price, wherein the receipt may also show the MSRP and the Discounted Price, and may also include any other transaction information that may be required by, e.g., the card network and any applicable laws/regulations (e.g., such as listing transaction Type as Debit, listing the card network (e.g., VISA), etc., as may be required).

### CCPF Configuration/Discount Price Determination

The preconfigured CCPF (corresponding to the cash discount, i.e., the difference between the MSRP and the Discounted Price) may be implemented (e.g., configured) in the transaction processing system in various ways, and may be merchant-selectable according to some embodiments. For instance, in some implementations, the CCPF for a merchant may be set in the transaction processing system (e.g., by an authorized/authenticated user/administrator) to comprise a percentage of the Discounted Price and/or a fixed amount, and may further be tiered. In some implementations, such CCPF preconfiguration may be set (e.g., selected and stored) via a user interface in a backend management/configuration application that then communicates the CCPF preconfiguration to the POS terminals (e.g., credit card machines) and/or other merchant transaction devices, which may locally store the CCPF preconfiguration and locally execute the CCPF reduction according to the CCPF preconfiguration.

By way of a non-limiting example, for purposes of additional clarity and illustration, in some implementations, wherein the Discounted Price (DP) equals the MSRP less the CCPF (i.e., DP=MSRP−CCPF), the CCPF (equal to the cash discount) may be preconfigured so as to be equal the sum of (i) a fixed transaction fee, f, and (ii) a product of the Discounted Price (DP) and an effective transaction rate, r (i.e., CCPF=r (DP)+f). In other words, preconfiguring the CCPF may comprise a user selecting/setting the effective transaction rate (r) (or, equivalently, selecting/setting the effective transaction percentage) and selecting/setting the fixed transaction fee value (f) in the transaction processing system. For a given purchase/sale transaction to be executed (where MSRP is a known/input and the DP is to be calculated), the transaction processing system will automatically calculate a Discount price (DP) based on the MSRP and the preconfigured/set values of the transaction rate value (r) and the transaction fee value (f).

So, for example, where the MSRP is the input into the transaction processing system (e.g., into the merchant POS terminal/device), the Discount Price may be calculated, for example, by first calculating CCPF=[r(MSRP)+f]/(1+r), and then calculating DP=MSRP−CCPF.

Alternatively but equivalently, for example, where the MSRP is the input for the transaction processing system, the Discount Price (DP) may be directly calculated (e.g., without first calculating a CCPF amount) as DP=(MSRP−f)/(1+r), and the cash discount may be calculated as the difference between the MSRP and the DP (e.g., the cash discount may be calculated if it is desired and/or needed for displaying amount saved in a receipt, and/or for reporting an “Unclaimed or Unrealized Discount” for a card transaction, etc.).

### MSRP Input to Payment Terminal/Payment Application

It may be understood that in various embodiments, the input and/or the determination of the MSRP from which the CCPF is removed (e.g., deducted) the determination of the Discounted Price may be implemented in various ways. For example, a merchant device may include a point-of-sale terminal or a similar device (fixed or mobile terminal/device) used by a merchant when processing transactions with a customer in person, and the merchant device may receive (and store) the MSRP for a given transaction directly via any known input (and/or input/output) device such as a keypad (physical keys and/or virtual/soft-keys), an optical scanner (e.g., reading a barcode or QR code), an RFID and/or NFC scanner, and the like. A keypad interface may, for example, include a numerical keypad and/or a keypad array containing softkeys for selecting preconfigured items offered for sale by the merchant (where selection of the item automatically enters the corresponding preconfigured price (e.g., the MSRP of the item). As further described hereinbelow, the merchant/payment device/terminal may include a calculator utility/application (which, in some implementations, may be extended to a simple cash register application) that may be selectively used to (i) automatically convert a cash price entered via the keypad (or entered via one or more other inputs in some embodiments) into a MSRP and/or (ii) automatically convert a MSRP entered via the keypad (or entered via one or more other inputs in some embodiments) into a Discount Price.

In some transactions, the MSRP from which the CCPF is removed may be the sum total of prices for two or more items (e.g., goods and/or services, such as separate restaurant menu items, different individual store goods, separate services, etc.) that are being purchased. In such multi-item purchase transactions, the transaction processing system may receive and sum the MSRP price inputs (e.g., via numerical keypad, bar-code scanning, RFID, etc.) for the individual items to arrive at the (total) MSRP from which the CCPF is removed to determine the Discounted Price (the cash price). In some multi-item implementations, wherein the prices of the item(s) is a cash price, the calculator utility/application may be selectively used to automatically convert the total of the item cash prices entered via the keypad (or via one or more other inputs in some embodiments) into a (total) MSRP (card payment price) for implementing a TCD payment transaction.

### Integrated Calculator Utility|Cash Register/Discount Calculator| Register/Cash Discount Calculator

Some embodiments of the payment processing methods and systems (e.g., the payment terminal/device hardware and/or the software, and/or the processes executed thereby) may include a calculator utility/application (also referred to herein as, e.g., a Register Discount Calculator or Register/Discount Calculator or Register/Cash Discount Calculator) that, for example, may facilitate generating a MSRP (List Price) value that is stored in the payment terminal/device for initiating a TCD transaction process based on entering a Cash/Discount Price amount. In various implementations, the calculator utility/application may alternatively or additionally facilitate confirming (and displaying) a Discount Amount based on entering a Cash/Discount Price amount.

Utility of the Cash Register may be further appreciated by first considering the following illustrative steps of a non-limiting example of a TCD payment transaction:
1. Let us say a sandwich and drink costs $10. The merchant adjusts the MSRP (List Price) to reflect CCPF. Hence the merchant prices the product as $10.40. The merchant enters $10.40 as the transaction amount.
2. Let us say the CCPF is configured as 4%. The POS machine removes 40 cents from the MSRP to arrive at a Discounted Price of $10.00.
3. The consumer is given a choice to pay either $10.00 as Cash or $10.40 using credit or debit cards.

It may be appreciated that an assumption in the foregoing is that the Merchant will reprice all items in the store to reflect credit card price (e.g., the displayed in-store prices are set to the MSRP).

But, as a practical matter, not all merchants will necessarily reprice the items in the store to reflect the MSRP. Accordingly, to help merchant's arrive at the MSRP in such cases, some embodiments of a payment terminal/device (e.g., the POS terminal) may include a calculator utility application (e.g., a Register/Discount Calculator utility/application) as part of and/or integrated with the payment application. Unlike using a traditional handheld calculator or other calculator that is not integrated with the payment terminal payment application (e.g., such as a calculator on a computer or smartphone that is not itself implementing the merchant/POS payment application) and that would require the merchant to remember the calculated amount and key in the value manually into the payment terminal/payment application, such a Register/Discount Calculator utility in accordance with some embodiments will automatically feed a calculated MSRP into the payment transaction flow.

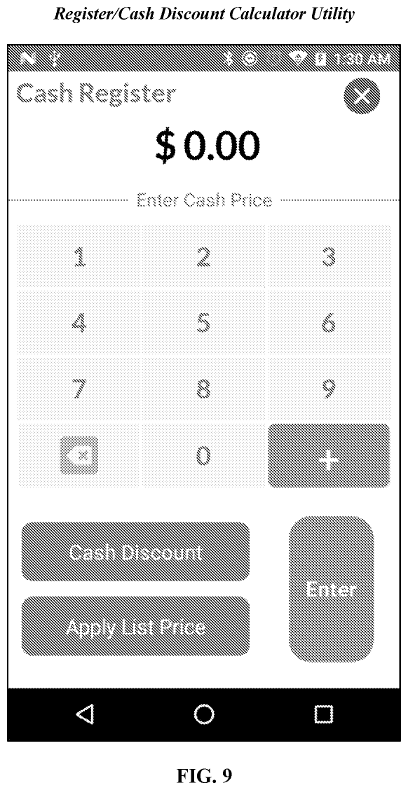

FIG. 9 depicts an illustrative display/screen of a Register/Cash Discount Calculator utility on the user interface of the POS payment application and the credit card machine (e.g., a POS terminal) of FIG. 5. The Cash Discount Calculator/Register (“Cash Register” for ease of reference) utility may, for example, be invoked from the screen/display of FIG. 5 by selecting the calculator icon touch-key at the top right of the screen/display of FIG. 5.

### (“Apply List Price” Utility/Function)

The illustrative Cash Register utility display/screen shown in FIG. 9 includes an “Enter Cash Price” prompt that, in some embodiments, may be generated following selection of the “Apply List Price” softkey. With this prompt displayed, upon entering a Cash (Discounted) Price value (e.g., $13.00) and selecting the “Enter” key, in some embodiments, the MSRP (List Price) (e.g., $13.52) will be displayed in the Cash Register utility (along with, in some implementations, the “Enter Cash Price” prompt replaced by a “Hit Enter to Continue” prompt). Then, upon again selecting the “Enter” key, the MSRP will be automatically fed into the payment transaction flow; for example, in some embodiments, the POS payment terminal/application will automatically display a user interface screen corresponding to that of FIG. 6, with the calculated MSRP value and the Discount Price value displayed in the fields below the “Cash Payment” and “Card Payment” text, thus automatically launching into the payment transaction application flow from the calculator. In an alternative implementation, the MSRP will be automatically fed into the transaction flow upon entering the Cash (Discounted) Price and selecting the “Enter” key as per the above step (i.e., feeding the MSRP into the transaction flow will not require again selecting “Enter” (nor prompting the user to “Hit Enter to Continue”)).

In yet another illustrative alternative embodiment of an “Apply List Price” process flow that may be implemented in connection with the Cash Register utility display/screen shown in FIG. 9, the “Enter Cash Price” prompt may be displayed upon activating the Cash Register utility (i.e., without first selecting the “Apply List Price” key). Then, with this prompt displayed, upon entering a Cash (Discounted) Price and selecting the “Apply List Price” key, in some embodiments, the MSRP (List Price) will be displayed in the Cash Register utility (along with, in some implementations, the “Enter Cash Price” prompt replaced by a “Hit Enter to Continue” prompt). Then, upon again selecting the “Enter” key, the MSRP will be automatically fed into the payment transaction flow; for example, in some embodiments, the POS payment terminal/application will automatically display a user interface screen corresponding to that of FIG. 6, with the calculated MSRP value and Discount Price value displayed in the fields below the “Cash Payment” and “Card Payment” text, thus automatically launching into the payment transaction application flow from the calculator. In an alternative implementation, the MSRP will be automatically fed into the transaction flow upon entering the Cash (Discounted) Price and selecting the “Apply List Price” key as per the above step (i.e., feeding the MSRP into the transaction flow will not require selecting “Enter” (nor prompting the user to “Hit Enter to Continue”) after the “Apply List Price” key has been selected).

### (“Cash Discount” Utility/Function)

Some embodiments of a Cash Register (such as the illustrative embodiment having a user interface display screen as depicted in FIG. 9) may also provide for confirming/displaying the Discount Amount (i.e., the difference between MSRP and the Discount Price) and then selectively launching directly into the payment transaction application flow.

For example, in some embodiments of a Cash Register employing the user interface display screen of FIG. 9, the “Enter Cash Price” prompt may be generated following selection of the “Cash Discount” softkey. With this prompt displayed, upon entering a Cash (Discounted) Price value (e.g., $13.00) and selecting the “Enter” key. In some embodiments, the Discount Amount (i.e., the difference between MSRP and Discount Price; e.g., $0.52) will be displayed in the Cash Register utility (along with, in some implementations, the “Enter Cash Price” prompt replaced by a “Hit Enter to Continue” prompt). Then, upon again selecting the “Enter” key, the MSRP (List Price) corresponding to the entered Cash (Discounted) Price will be automatically fed into the payment transaction flow; for example, in some embodiments, the POS payment terminal/application will automatically display a user interface screen corresponding to that of FIG. 6, with the MSRP value and Discount Price value displayed in the fields below the “Cash Payment” and the “Card Payment” text, thus automatically launching into the payment transaction application flow from the calculator.

In an illustrative alternative embodiment of a “Cash Discount” process flow that may be implemented in connection with the Cash Register utility display/screen shown in FIG. 9, the “Enter Cash Price” prompt may be displayed upon activating the Cash Register utility (i.e., without first selecting the “Cash Discount” key). Then, with this prompt displayed, upon entering a Cash (Discounted) Price value (e.g., $13.00) and selecting the “Cash Discount” key, the Discount Amount (i.e., the difference between the MSRP and the Discount Price; e.g., $0.52) will be displayed in the Cash Register utility (along with, in some implementations, the “Enter Cash Price” prompt replaced by a “Hit Enter to Continue” prompt). Then, upon again selecting the “Enter” key, the MSRP (List Price) corresponding to the entered Cash (Discounted) Price will be automatically fed into the payment transaction flow; for example, in some embodiments, the POS payment terminal/application will automatically display a user interface screen corresponding to that of FIG. 6, with the MSRP value and the Discount Price value displayed in the fields below the “Cash Payment” and the “Card Payment” text, thus automatically launching into the payment transaction application flow from the calculator.

In the foregoing illustrative Discount Calculator/Cash Register implementations (e.g., including the various Apply List Price” utility/function and (“Cash Discount” utility/function implementations), as described, the MSRP (List Price) may be automatically fed into the payment transaction flow by, for example, automatically proceeding from the Discount Calculator/Cash Register utility to displaying a user interface screen corresponding to that of FIG. 6, with the MSRP value and Discount Price value displayed in the fields below the “Cash Payment” and “Card Payment” text, thus automatically launching into the payment transaction application flow from the calculator utility. By way of non-limiting example, however, in various alternative implementations the MSRP (List Price) may be automatically fed into the payment transaction flow by, for example, automatically proceeding from the Discount Calculator/Cash Register utility to displaying a user interface screen corresponding to that of FIG. 5 (with the MSRP displayed), from which a user may then selectively proceed to the user interface of FIG. 6 (e.g., upon hitting the “OK” softkey on the display of FIG. 5).

In accordance with some embodiments, the Calculator/Cash Register utility may be an optional feature that, for example, may be enabled or disabled directly on the merchant/payment terminal (e.g., the configuration settings accessible via the user interface) and/or via a dedicated server and/or a cloud-based Terminal Management System, such as the Dejavoo STEAM Terminal Management System referred to herein.

In addition, it may be understood that the Calculator/Cash Register utility functionality and user interface may be implemented in various ways and be configurable to provide the user/Merchant access to one or more of the above-described (and possibly other) calculation functions (e.g., selection of one or more functions from among the “Cash Discount” and the “Apply List Price” functions and possibly additional functions). For instance, in various implementations, functions available via the default user interface of the calculator utility/application may be set on the merchant/payment terminal (e.g., the configuration settings accessible via the user interface) and/or via a dedicated server and/or cloud based Terminal Management System.

### (Multiple Items-Item-by-Item Cash Price Entry|Itemized Dual-Price Listing)

In accordance with some embodiments according to the present disclosure, the Cash Register/Discount Calculator utility (e.g., also referred to herein as the “Cash Register” utility, for ease of reference) that is implemented by/integrated into the payment application running on the terminal may also provide for entering, for a given transaction, two or more cash values corresponding to respective discounted prices for two or more items being purchased. In such implementations, the Discount Calculator will calculate/determine the MSRP (List Price) for each item, while also summing/totaling the respective Cash and the MSRP prices for each item (or carrying out similar and/or equivalent summing/totaling calculations, such as summing the MSRP item prices (or Cash prices) and calculating a total Cash/Discount price (or the total MSRP) based on the total MSRP (or the total Cash/Discount price)). A listing of such dual pricing for each item (an itemized dual-pricing listing) may be displayable to the user (e.g., preferably along with the total Cash Discount cost and the total MSRP cost, preferably also in “real time” as the item cash prices are being entered) via the terminal device user interface and/or via another device in communication with the terminal device payment application (e.g., such another device may, for example, be a pole display or register display at the POS, the customer's mobile phone, a consumer PAD-like PIN Pad device, etc.). In various embodiments, such an itemized dual-price listing may alternatively or additionally be provided to the customer as a printed or electronic receipt. (As such, for example, full compliance is ensured even if the merchant does not list/display item prices on the merchant's item/product shelves.)

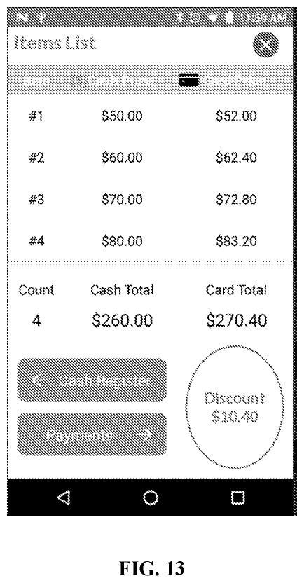

By way of a non-limiting example, with reference to the Discount Calculator of FIG. 9, if the user (e.g. the merchant) enters an item Cash price value followed by a plus (+) sign, the Discount Calculator will then sum the next Cash price value entered by the user/merchant to a running sum, while also calculating the corresponding MSRP for each item as its Cash price value is entered (as well as, in some implementations, adding each successively calculated MSRP to a running total MSRP). Upon entering the last item Cash price, the user/merchant may then select the “Enter” softkey, which may then cause the terminal user interface to display an itemized dual-pricing listing, such as that shown in FIG. 13 by way of non-limiting example.

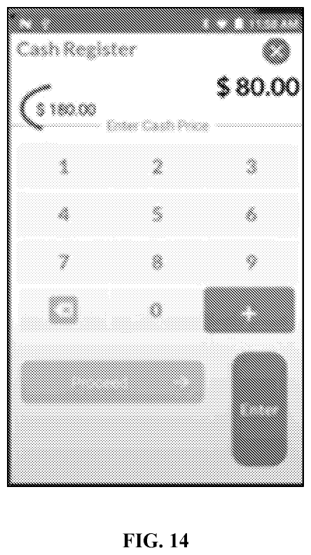

In an illustrative alternative implementation, once the user/merchant enters a plus (+) sign after entering the first item cash discount price, the Discount Calculator interface display may be updated to a display such as that shown in FIG. 14, wherein the display includes (i) a first field for displaying the value of each cash item as it is typed into the Discount Calculator (e.g., the field comprising $80 in the upper right), and (ii) a second field for displaying the running sum of the entered cash values ($180 in this example, wherein the $180 will become $260 once the user/merchant selects the plus softkey (if another cash value is to be entered) or selects the “Enter” softkey (e.g., if $80 is the last cash value for the last item to be entered for the transaction, which it is in this example). Then, after selecting “Enter” upon entering the last item Cash price (causing the total cash value amount to be displayed where the $180.00 is shown), the user/merchant may then select the “Proceed” softkey, which may then cause the terminal user interface to display an itemized dual-pricing listing, such as that shown in FIG. 13 by way of a non-limiting example.

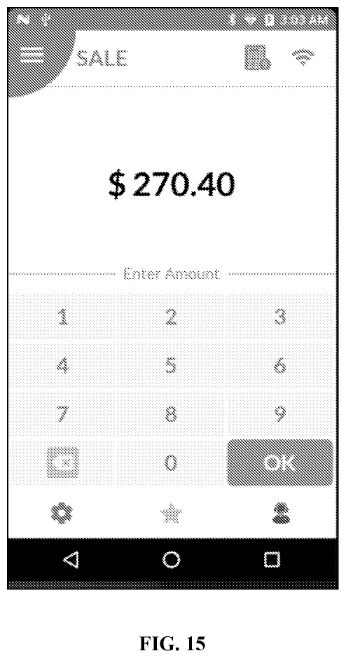

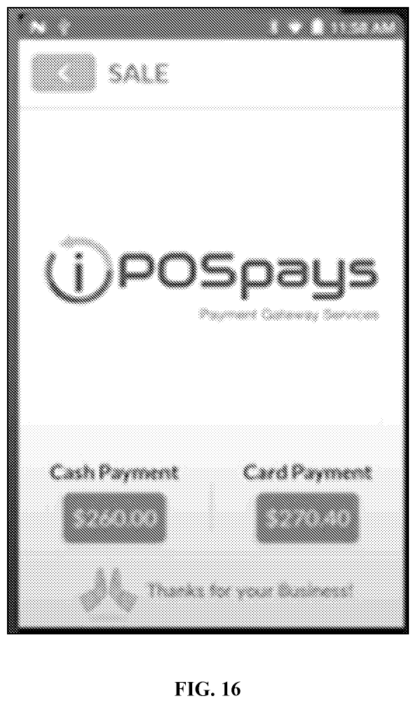

More specifically, as depicted in FIG. 13, the Cash price for four items was entered into the Discount Calculator, which determined the respective card prices for each item as well as the Cash Total (shown as $260.00 in this example), the Card Total (shown as $270.40 in this example), and the Discount Amount (shown as $10.40 in this example). This display may be visible to and/or otherwise shown to the customer/consumer. And, as noted, it may alternatively or additionally be displayed (e.g., in real-time) on another device (e.g., external Pinpad, register, pole display, etc.) in communication with the terminal/payment application. Then, upon the “Payments” softkey being selected, the Card Total (MSRP total) will be automatically carried to a transaction screen (e.g., such as the display/screen of FIG. 5; alternatively, in some implementations, the process may automatically proceed to a display/screen such as FIG. 6.). By way of example, FIG. 15 depicts an illustrative transaction screen for this non-limiting example, showing the $270.40 MSRP/List price total for the transaction. Then, upon the user selecting the “OK” softkey, the process will proceed (as described for the above) such that the terminal/transaction application causes display of the dual price option as shown in FIG. 16 (e.g., corresponding to the display/screen of FIG. 6), so the customer/consumer may be presented with the Cash payment option and the Card payment option and select their preference (the customer or merchant selecting the corresponding “Cash Payment” or “Card Payment” softkey), so that the transaction may proceed accordingly (as described above in connection with various alternative illustrative embodiments).

### Multiple Items-Item-by-Item MSRP Price Entry/Itemized Dual-Price Listing

In accordance with some embodiments, the Cash Register/Discount Calculator utility that is implemented by/integrated into the payment application running on the terminal may alternatively or additionally provide for entering, for a given transaction, two or more MSRP/List values corresponding to respective MSRP/List prices for two or more items being purchased. In such implementations, the Discount Calculator will calculate/determine the Cash price (Discounted Price) for each item, while also summing/totaling the respective Cash and the MSRP prices for each item (or carrying out similar and/or equivalent summing/totaling calculations, such as summing the MSRP item prices (or the Cash prices) and calculating a total Cash/Discount price (or the total MSRP) based on the total MSRP (or total Cash/Discount price)). Except for the item-by-item prices entered into the Cash Register/Discount Calculator being item MSRPs rather than item Cash prices (and displayed values and some illustrative prompts being in the context of the MSRP), various implementations of such a Discount Calculator utility and its use in connection with effecting a payment transaction may, for example, proceed generally along the lines described hereinabove with respect to the payment transaction processing using the Cash Register utility for item-by-item entry of the cash prices.

For instance, as for item-by-item Cash price entry, a listing of such dual pricing for each item (an itemized dual pricing listing) may be displayable to the user (e.g., preferably along with the total Cash Discount cost and the total MSRP cost, preferably also in “real time” as the item cash prices are being entered) via the terminal device user interface and/or via another device in communication with the terminal device payment application (e.g., such another device may, for example, be a pole display or register display at the POS, the customer's mobile phone, a consumer PAD-like PIN Pad device, etc.). In various embodiments, such an itemized dual price listing may alternatively or additionally be provided to the customer as a printed or electronic receipt. (Such a Discount Calculator utility integrated into/with the payment application may, for example, facilitate transaction processing and/or compliance where in-store item prices are displayed only as the MSRPs (i.e., no listing of item Cash/Discount prices) or are not displayed. As such, for example, full compliance is ensured even if the merchant does not list/display item prices on the merchant's item/product shelves.)

By way of non-limiting example, a Discount Calculator may be invoked by a user/merchant selecting the calculator icon on the transaction screen/display of FIG. 5. (As further described below, whether the Discount Calculator or the Cash Register utility will be invoked by selecting the calculator icon may be based on a configuration setting, such as a STEAM system setting.) With the Discount Calculator utility user interface displayed, if the user (e.g. the merchant) enters an item MSRP value followed by a plus (+) sign, the Discount Calculator will then sum the next item MSRP value entered by the user/merchant to a running sum, while also calculating the corresponding Discount/Cash price value for each item as its MSRP value is entered (as well as, in some implementations, adding each successively calculated Discount/Cash price value to a running total Discount/Cash price). Upon entering the last item MSRP, the user/merchant may then select an “Enter” softkey on the Discount Calculator user interface, which may then cause the terminal user interface to display an itemized dual-pricing listing, such as that shown in FIG. 13 by way of a non-limiting example.

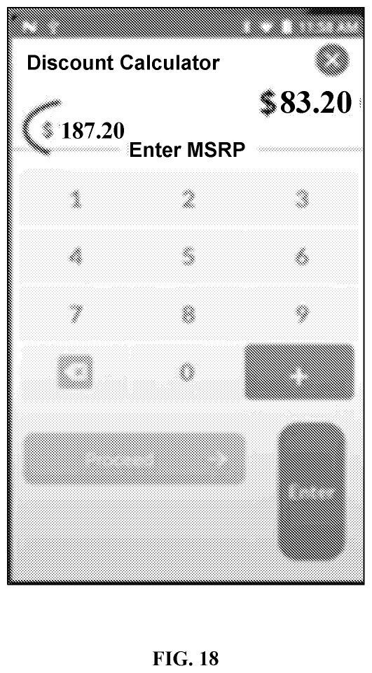

FIG. 18 depicts an illustrative implementation of a Discount Calculator user interface, in accordance with some embodiments. As a user/merchant enters a successive item MSRP following entry of a plus (+) sign after entering a previous item MSRP, the Discount Calculator interface may display (i) in a first field, the MSRP of each item as it is typed into the Discount Calculator (e.g., the field comprising $83.20 in the upper right), and (ii) in a second field, the running sum of the entered MSRP values ($187.20 in this example, wherein the $187.20 will become $270.40 once the user/merchant selects the plus softkey (if another cash value is to be entered) or selects the “Enter” softkey (e.g., if $83.20 is the last MSRP value for the last item to be entered for the transaction, which it is in this example). Then, after selecting “Enter” upon entering the last item MSRP (causing the total MSRP value amount to be displayed where the $187.20 is shown), the user/merchant may then select the “Proceed” softkey, which may then cause the terminal user interface to display an itemized dual-pricing listing, such as that shown in FIG. 13 by way of a non-limiting example.

More specifically, as depicted in FIG. 13, the MSRP price for four items was entered into the Discount Calculator, which determined respective cash prices for each item as well as the Cash Total (shown as $260.00 in this example), the Card Total (shown as $270.40 in this example), and the Discount Amount (shown as $10.40 in this example). This display may be visible to and/or otherwise shown to the customer/consumer. And, as noted, it may alternatively or additionally be displayed (e.g., in real-time) on another device (e.g., external Pinpad, register, pole display, etc.) in communication with the terminal/payment application. Then, upon the “Payments” softkey being selected, the Card Total (the MSRP total) will be automatically carried to a transaction screen (e.g., such as the display/screen of FIG. 5; alternatively, in some implementations, the process may automatically proceed to a display/screen such as FIG. 6.). By way of example, FIG. 15 depicts an illustrative transaction screen for this non-limiting example, showing the $270.40 MSRP/List price total for the transaction. Then, upon the user selecting the “OK” softkey, the process will proceed (as described for the above) such that the terminal/transaction application causes the display of the dual price option as shown in FIG. 16 (e.g., corresponding to the display/screen of FIG. 6), so the customer/consumer may be presented with the Cash and the Card payment options and select their preference (the customer or merchant selecting the corresponding “Cash Payment” or “Card Payment” softkey), so that the transaction may proceed accordingly (as described above in connection with various alternative illustrative embodiments).

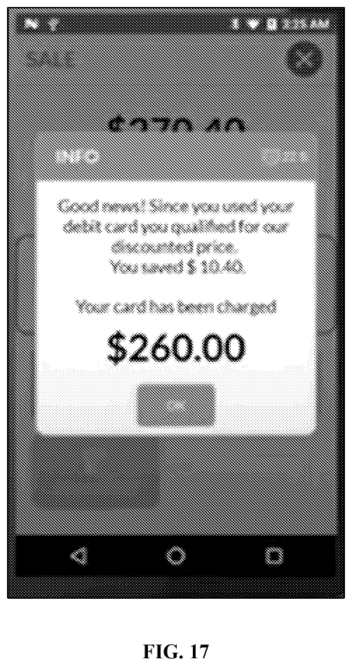

In accordance with the herein Debit-as-Cash disclosure, the Debit-as-Cash feature may also be implemented (e.g., via selective enablement using STEAM or other configuration interface/platform) in connection with such transactions that invoke the Cash Register/Discount Calculator utility (e.g., including for the item-by-item MSRP and/or the cash price entry). As described, in some embodiments, the payment device can automatically detect debit cards and provide the discount (e.g., execute the transaction at the Cash discount price) even though the consumer/customer selected Card Payment. FIG. 17 depicts an illustrative prompt that may be displayed to the consumer/customer (e.g., via the terminal user interface/display) in the event that the user selected Card Payment and presented a debit card that was automatically processed as a Cash payment.

In accordance with some embodiments, a “Card As Cash” function option may also be implemented that will effect/force the cash price discount on a Card transaction if the owner/merchant desires to provide a discount on payments made by Cards, even if the Card payments are set up/configured for the MSRP/List Price. For example an extended-time selection (“long press”; e.g., greater than 1 second) on the Card option icon/softkey long press on the card option at the dual pricing stage (e.g., FIG. 6) may trigger a question prompt such as “Discount List Price?” along with “Yes” and “No” options. If “Yes” is selected, a Card as Cash price will be offered and the transaction may then proceed to effect a Card as Cash payment at a Discounted price. Such an additional and/or alternative “Card As Cash” function option may be selectively implemented as an optional feature selectively enabled via a configuration setting (e.g. via a STEAM system, as may be further understood in view of the ensuing further description).

### TCD Management Application| Console

In some implementations, true cash discounting according to some embodiments of the present disclosure may be configured and enabled or disabled from a merchant terminal management system that may be configured to manage all merchant terminals of a given merchant. In some embodiments, such a terminal management system (or certain interfaces/consoles thereof) may be accessible via one or more merchant devices/terminals (e.g., subject to credential/identity authentication) and/or via another computing device (e.g., a PC, mobile phone, etc.) communicably coupled to a dedicated server and/or cloud-based Terminal Management System. In some implementations, such a cloud-based merchant terminal management system may be implemented as the STEAM (Secure Terminal Estate & Asset Management) Terminal Management System available from Dejavoo Systems of Mineola, NY, which is capable of, among other things, downloading a changed/updated configuration wirelessly to all merchant terminals/devices (of a given merchant) so as to change/update the behavior of the payment application according to the changed/updated configuration.

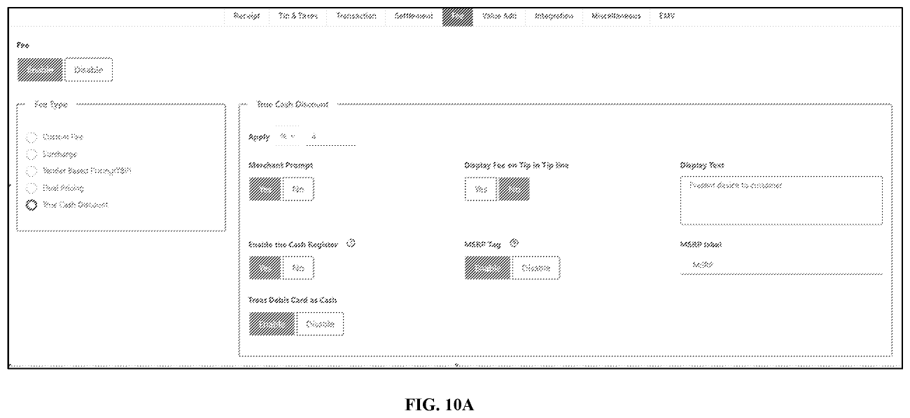

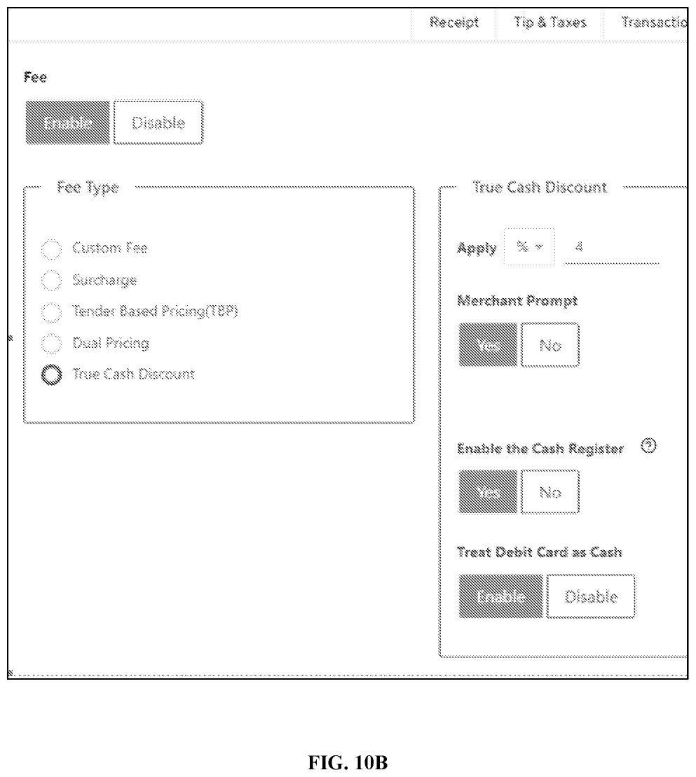

In accordance with some embodiments of the present disclosure, FIG. 10A depicts an illustrative configuration interface screen/display of a Terminal (parameter) management system, and FIG. 10B depicts a magnified portion of the interface screen/display shown in FIG. 10A. As shown, this selected illustrative screen/display within the application is for configuring Fee parameters/options, and includes a “Fee Type” field in which the selected Fee Type (among various Fee Type options) depicted is “True Cash Discount,” thereby selecting the configuration to enable POS terminals/devices to implement True Cash Discounting according to embodiments of the present disclosure.

As shown, with the “True Cash Discount” Fee Type selected, the screen/display includes a “True Cash Discount” field that provides for specifying/configuring a number of parameters/options. For instance, the “True Cash Discount” field includes an “Apply %” field (with a % selection drop down) in which, by way of example, the value “4” is entered (corresponding to configuring the CCPF at 4%; e.g., r=0.04). (Note, in this illustrative embodiment, there is no fixed fee (f) parameter setting, so effectively f=0 in connection with the hereinabove illustrative description of CCPF.)

As also shown, the “True Cash Discount” field also includes a “Treat Debit Card as Cash” field containing “Enable” and “Disable” softkeys for selectively configuring the Debit-as-Cash feature/option to be enabled or disabled, respectively (which may depend, for example, on whether the no-dual-price-listing condition is or is not satisfied, respectively, as may be confirmed by the merchant). Accordingly, in this illustrative embodiment, by selecting the True Cash Discount Fee Type and selecting “Enable” in the “Treat Debit Card as Cash” field (e.g., based on the merchant having confirmed that the no-dual-price-listing condition is satisfied), then (upon this configuration being downloaded to and activated on the merchant transaction terminals/devices) the merchant terminals/devices will be configured to implement TCD pricing and payment processing with the Debit-as-Cash feature enabled. Alternatively, by selecting the True Cash Discount Fee Type and selecting “Disable” in the “Treat Debit Card as Cash” field (e.g., based on the merchant either having confirmed that the no-dual-price-listing condition is not satisfied, or not having confirmed whether (or not) the no-dual-price-listing is satisfied), then (upon this configuration being downloaded to and activated on the merchant transaction terminals/devices) the merchant terminals/devices will be configured to implement TCD pricing and payment processing without the Debit-as-Cash feature enabled.

As also shown in FIG. 10A and FIG. 10B, the “True Cash Discount” field includes an “Enable the Cash Register” field to configure the Cash Register utility to be selectively enabled or disabled. For instance, when the configuration is set for the Cash Register to be disabled (by selecting the “No” key in the “Enable the Cash Register” field), then, for example, when such configuration is downloaded and activated on a POS terminal/device, the calculator icon displayed on the display/screen of FIG. 5 may, for example, either remain displayed but be inactive or not be displayed/visible (with the corresponding screen location not being active to launch the calculator), according to various alternative implementations. And when the configuration is set for the Cash Register to be enabled (by selecting the “Yes” key in the “Enable the Cash Register” field), then, for example, when such configuration is downloaded and activated on a POS terminal device, the calculator icon displayed on the display/screen of FIG. 5 will be active, wherein selection of the calculator icon will cause the Cash Register to be activated with the screen/interface of, for example, FIG. 9 (and/or FIG. 14 and/or FIG. 18) being displayed on the POS terminal/device.

Whether the Cash Register utility (e.g., employing a user interface such as FIG. 9 and/or FIG. 14) or Discount Calculator utility (e.g., employing a user interface such as FIG. 18) will be invoked may be based on a configuration setting, such as a STEAM system setting (not explicitly shown in FIG. 10A and FIG. 10B). In view of the present disclosure, however, it will be understood that some embodiments may provide (e.g., by a configuration setting) for both the Cash Register and Discount Calculator utilities to be accessible to (and selectively invokable by) a user/merchant via, e.g., the transaction user interface display (e.g., FIG. 5) of the terminal device, such as by having two distinguishable softkeys/icons on the transaction user interface display for invoking these respective utilities.

### Alternative Illustrative Embodiment

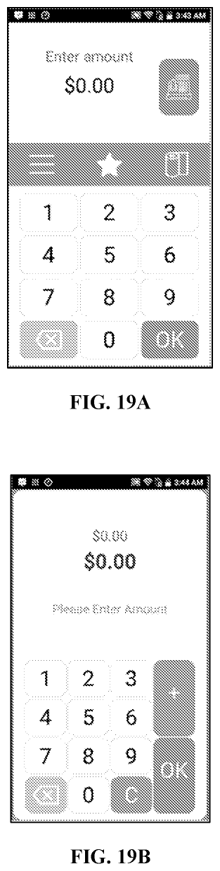

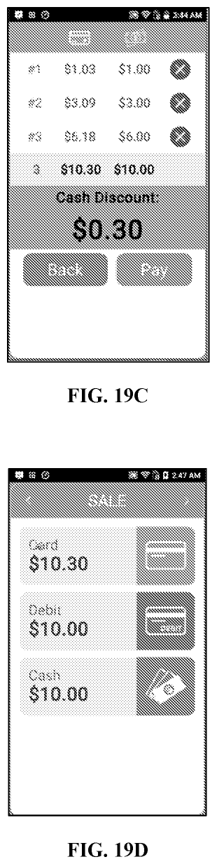

In view of the foregoing illustrative embodiments, it will be understood that in various typical implementations, a given merchant will select the payment transaction process configuration parameters (e.g., via STEAM) that align with how the merchant implements the pricing and cash discounts and/or the in-store item price display (e.g., displaying the MSRP/card price, or displaying the Cash/Discount price, etc.). For instance, since the merchant knows how they are posting prices in their store, they will have the Cash Register/Discount Calculator utility configured accordingly (via STEAM). So—because the merchant knows how item prices are displayed and how the Cash Register/Discount Calculator has been configured, various user interface prompts do not necessarily have to include the “MSRP” and/or the “Cash” Price/value indicia. For example, in some implementations, the Cash Register/Discount Calculator utility does not necessarily have to include an “Enter Cash Price” or an “Enter MSRP” prompt—the prompt can simply be “Enter amount.” Likewise, in some implementations, the transaction screen may not require specifying the “Enter MSRP” (e.g., such as when the merchant knows that displayed item prices are the MSRPs and/or that the value entered into the transaction screen will be the MSRP). By way of a non-limiting example, FIG. 19 (FIGS. 19A-19D) depict illustrative user interface screens wherein a transaction screen and a Cash Register/Discount Calculator utility do not include indicia or prompts specifying the “MSRP” or the “Cash” (e.g., because the merchant knows how the item prices are displayed and whether the Cash Register/Discount Calculator has been configured as a Cash Register utility (for entering cash value(s)) or as a Discount Calculator (for entering the MSRP(s)).

More specifically, FIG. 19A is an illustrative transaction processing screen corresponding to that of FIG. 5, but with an “Enter amount” prompt instead of an “Enter MSRP” prompt. FIG. 19B is an illustrative Cash Register or a Discount Calculator user interface (invoked via the Register icon/softkey on the FIG. 19A user interface display) corresponding functionally to, e.g., the Cash Register user interface of FIG. 14 (see also, e.g., FIG. 9) or Discount Calculator user interface of FIG. 18, depending on a configuration setting (e.g., in STEAM). As shown, FIG. 19B includes an “Enter Amount” prompt instead of an “Enter Cash Price” of FIG. 14 or an “Enter MSRP” prompt of FIG. 18. Like FIG. 14 and FIG. 18, the user interface of FIG. 19B includes two numerical fields for respectively displaying entered item prices (entered either as the MSRP or the Cash price, according to the configuration set by a merchant) and a running total price. FIG. 19C shows an illustrative itemized and total dual-price listing (card and cash prices) corresponding to the user interface display of FIG. 13 (but for a different illustrative transaction comprising differently priced items). Upon selection of the “Pay” icon/softkey on the dual-price listing display of FIG. 19C, the transaction process may proceed to cause display of the user interface/display of FIG. 19D (e.g., corresponding to the user interface displays shown in FIG. 6 and/or FIG. 11A and/or FIG. 11B), from which payment type may be selected.

### Payment/POS Terminal Hardware/Software

As will be understood by those skilled in the art in view of the present disclosure and known payment processing technology (e.g., including payment processing devices/systems, such as merchant payment/POS systems and terminals (e.g., including credit card machines/terminals, etc.), including hardware and associated software, etc.) as well as known cash discounting mechanisms (such as described in the above Background section, including the DTI patents incorporated herein by reference in their entirety), a TCD transaction processing system/device in accordance with some embodiments of the present disclosure (such as some implementations of illustrative embodiments described herein) may comprise any of myriad commercially available merchant terminals/devices (e.g., credit card machine/terminal, smartphone, tablet, PDA, etc.) that may be present to the customer at the point-of-sale (POS) (e.g., fixed or mobile/portable POS terminals), each merchant terminal/device comprising at least one processor as well as memory/storage (e.g., DRAM, Flash, and/or other non-transient computer-readable medium), wherein code (e.g., software and/or firmware) stored on at least one computer-readable medium of such a merchant terminal/device is adapted/to include TCD code (e.g., application code) for execution by the at least one processor to cause the merchant terminal to implement true cash discounting processes in accordance with embodiments according to the present disclosure. In some implementations, such code may include code for the merchant terminal/device to selectively execute the MSRP calculation utility in accordance with some embodiments described hereinabove.

As will also be understood by those skilled in the art, such merchant terminals/devices may include various hardware (e.g., communication circuitry, human-machine interface(s), etc.) and stored code for handling cash and card payment transactions, such as for reading or entering an MSRP and/or other purchase information, communicating (e.g., displaying) the MSRP and the Discount price options to a consumer/purchaser, receiving input indicative of whether a payment will be by cash or card, communicating with a payment processing system such as a merchant acquirer and/or its affiliates (e.g., such as an ISO) for effecting card transactions (e.g., obtaining card approval, reporting transaction information, etc.), providing/outputting a transaction receipt, etc.

In some TCD implementations according to the present disclosure, merchant terminals/devices may include a mobile phone, tablet, PDA or any other device capable of, for example, processing card-based payment transactions, including, for example, by means of a built-in or an attachable card-reader, and/or NFC communications, etc., for reading card information. By way of non-limiting example, illustrative commercially available hardware and software solutions that may be adapted to implement TCD transaction processing in accordance with the present disclosure include payment the terminals and the terminal software available from Dejavoo Systems of Mineola, NY., such as (but not limited to) their Android Terminals and AURA and IPOSPAYS software.

In some embodiments, a transaction processing system may also comprise a transaction management application running on a merchant/payment terminal/device and/or on a computer/server that may be communicably coupled to merchant terminals/devices via one or more wired/cabled and/or wireless communication networks (e.g., a cloud-based transaction management system; e.g., IPOSPAYS and/or Dejavoo's STEAM).

### Illustrative, Non-Limiting Features/Advantages of Some Embodiments

In view of the present disclosure, including the above-described illustrative embodiments, those skilled in the art will understand that implementing True Cash Discounting in accordance with various embodiments according to the present disclosure provides for many features and advantages, particularly for merchants but for customers as well. For instance, it may be appreciated that one or more of the following features and/or advantages (and attendant advantages thereof) may be provided in various implementations:
No Fee is added to the transaction amount. The entered MSRP is discounted (and hence the name True Cash Discount) for the customers who may want to pay by card. No mention of the word “Fee” anywhere in the TCD POS application (e.g., via merchant and consumer user interfaces), report, or receipts.
Doesn't give the consumer the impression that they are paying extra to use their credit/debit cards. Rather they get a discount if they choose to pay by cash.
The cash receipt and/or terminal display given to the consumers may show the money that they saved because they chose to pay by Cash or MSRP receipt as chosen by the operator or the Consumer.
Enables Debit to be considered as Cash with Auto-Calculation of the Discount and Auto-Applying it to the transaction flow without re-entry, thus seamlessly providing a discount to the customer.
Eliminates the manual calculation and key entry of the MSRP by the merchant (e.g., such as where the above-described calculator utility is implemented).
Answers a consumer question “what's my saving” before the transaction, as per the discount for Cash Or Debit.
Single button auto conversion of the MSRP amount into a Dual or a Multi Pricing display to clearly enable consumer's payment choice.
No need for any disclaimer and the compliance arising from the same. The TCD program discounts the MSRP hence there is no need for disclosures.

It will be understood that in some TCD implementations, a transaction may include taxes, tips, and/or other fees (e.g., shipping, handling, etc.), coupon discounts, and/or other adjustments applied by the merchant. Those skilled in the art will understand in view of the present disclosure how to implement TCD transaction processing so that transactions may incorporate such taxes, fees, etc., and will further understand that such incorporation will not materially alter TCD transaction processing in accordance with embodiments according to the present disclosure. Accordingly, for purposes of clarity of exposition, embodiments expressly describing such taxes and/or other fees, etc., are not explicitly included herein.

It will also be understood that some embodiments according to the present disclosure may be implemented in connection with cloud POS or eCommerce transactions that involve card and ACH payments as Cash.

The present invention has been illustrated and described with respect to some specific illustrative embodiments thereof, which embodiments are merely illustrative of some of the principles of some embodiments of the invention and are not intended to be exclusive or otherwise limiting embodiments. Accordingly, although the above description of the illustrative embodiments of the present invention, as well as various illustrative modifications and features thereof, provides many specificities, these enabling details should not be construed as limiting the scope of the invention, and it will be readily understood by those persons skilled in the art that the present invention is susceptible to many modifications, adaptations, variations, omissions, additions, and equivalent implementations without departing from this scope and without diminishing its attendant advantages.

For instance, except to the extent necessary or inherent in the processes themselves, no particular order to the steps or the stages of methods or processes described in this disclosure, including the figures, is implied. In many cases the order of process steps may be varied, and various illustrative steps may be combined, altered, or omitted, without changing the purpose, effect or import of the methods described. Similarly, the structure and/or function of a component may be combined into a single component or divided among two or more components. It is further noted that the terms and expressions have been used as terms of description and not terms of limitation. There is no intention to use the terms or expressions to exclude any equivalents of features shown and described or portions thereof. Additionally, the present invention may be practiced without necessarily providing one or more of the advantages described herein or otherwise understood in view of the disclosure and/or that may be realized in some embodiments thereof. It is therefore intended that the present invention is not limited to the disclosed embodiments but should be defined in accordance with the claims that are based on the present disclosure, as such claims may be presented herein and/or in any patent applications claiming priority to, based on, and/or corresponding to the present disclosure.

1. A payment device comprising at least one processor operable in executing program code stored on at least one computer readable medium to cause the payment device to:
(i) store a merchant suggested retail price (MSRP) or a List Price value for a payment transaction to be executed;
(ii) determine (e.g., calculate) a Discounted Price by discounting the MSRP or the List Price by a Discount Amount;
(iii) receive an input indicative of whether the payment for the transaction will be made by cash or by card;
(iv) execute the transaction according to the Discounted Price in the event that the input indicates that the transaction payment is by cash; and
(v) execute the transaction according to the MSRP in the event that the input indicates that the transaction payment is by card and the card used is a credit card.

2. The payment device according to claim 1, wherein the Discount Amount equals a credit card processing fee (CCPF) that would be incurred if the transaction at the Discounted Price were to be paid by a credit card, and wherein the MSRP value (or the List Price) is discounted by the Discount Amount such that Discounted Price equals the MSRP value (or the List Price) less the Discount Amount.

3. The payment device according to claim 2, wherein the Discount Price is determined by (i) calculating the CCPF and then deducting the CCPF from the MSRP, or (ii) calculating the Discounted Price as a function of the MSRP without first calculating the CCPF and such that the difference between the MSRP and the Discounted price equals the CCPF.

4. The payment device according to claim 1, wherein to execute the transaction according to the MSRP in the event that the input indicates that the transaction payment is by card and the card used is a credit card, the payment device is operable to communicate with at least one of a payment gateway, a payment processor (e.g., ISO), and a merchant acquirer.

5. The payment device according to claim 1, wherein the program code stored on the at least one computer readable medium will cause the payment transaction processing system to execute the transaction according to the MSRP in the event that the input indicates that the transaction payment is by card and the card used is a debit card.

6. The payment device according to claim 5, wherein the payment device is configured such that a debit card payment transaction that is executed will necessarily be according to the MSRP and may not be according to the Discounted Price.

7. The payment device according to claim 1, wherein the program code stored on the at least one computer readable medium will cause the payment transaction processing system to execute the transaction according to the Discounted Price in the event that the input indicates that the transaction payment is by card and the card used is a debit card.

8. The payment device according to claim 7, wherein the computer readable medium, i.e., the transaction device, automatically determines that the transaction may qualify to be executed at the Discount Price, with such automatic determination being made without a priori user input specifying that the transaction may and/or should qualify to be executed at the Discount Price.

9. The payment device according to claim 8, wherein the computer readable medium, i.e., the transaction device, automatically executes the transaction at the Discount Price, with such automatic execution being made without a priori user input specifying that the transaction may and/or should be executed at the Discount Price.

10. The payment device according to claim 1, wherein the payment device is configured to receive the input indicative of whether payment for the transaction will be made by cash in response to the payment device displaying information for a user to be informed and/or prompted that the payment will be according to the MSRP (or the List Price) if the consumer pays by card and will be according to the Discounted Price if the consumer pays by cash.

11. The payment device according to claim 1, wherein the payment device is any one of a credit card machine, a POS terminal, a smartphone, a tablet, a PDA, and any other device capable of processing a card-based payment transactions or accepting a credit card payment from a consumer/purchaser.

12. The payment device according to claim 11, wherein the payment device comprises at least one of a built-in or attachable/removable card magnetic-strip reader, circuitry configured for contact card-reader, NFC communication circuitry configured to receive card information, and/or NFC communications, etc., for reading card information, a contact chip reader, and/or a contactless (e.g., a NFC) reader for card chips or other contactless-payment-devices (e.g., a mobile phone executing a card payment application, such as Apple Pay).

13. The payment device according to claim 12, wherein the payment device comprises a touch-screen human-machine interface (HMI) and/or a mechanical/tactile keypad.

14. A transaction management system comprising a user interface configured to receive user inputs that specify at least one configuration parameter of a payment device, wherein a payment device updated according to the specified at least one configuration parameter will be configured as the payment device according to claim 1.

15. The transaction management system according to claim 14, wherein the transaction management system is configured as a cloud-based terminal management system.

16. A payment transaction device and/or system configured to automatically execute a debit card payment transaction at a Discounted Price that is less than a price at which the transaction device and/or system would execute the transaction for a credit card payment.

17. The payment transaction device and/or system according to claim 16, wherein the transaction device automatically executes the transaction at the Discount Price, with such automatic execution being made without a priori user input specifying that the transaction may and/or should be executed at the Discount Price.

18. A payment transaction device and/or system configured to automatically determine that a debit card payment transaction may qualify to be executed at a Discounted Price that is less than a price at which the transaction device and/or system would execute the transaction for a credit card payment, wherein such automatic determination is made without a priori user input specifying that the transaction may and/or should qualify to be executed at the Discount Price.
